(19) United States
(12) Patent Application Publication
(10) Pub. No.: US 2024/0375961 A1
(43) Pub. Date: Nov. 14, 2024

(54) Production of Graphite from a Sustainable Source

(71) Applicant: Global Graphene Group, Inc., Dayton, OH (US)

(72) Inventors: Hammad Younes, Dayton, OH (US); Bor Z. Jang, Centerville, OH (US)

(73) Assignee: Global Graphene Group, Inc., Dayton, OH (US)

(21) Appl. No.: 18/315,207

(22) Filed: May 10, 2023

(51) Int. Cl. C01B 32/205; C01B 32/318; C01B 32/348

(52) U.S. Cl. CPC C01B 32/205; C01B 32/318; C01B 32/348; C01P 2002/52; C01P 2002/60; C01P 2002/72; C01P 2002/78; C01P 2002/82; C01P 2004/80; C01P 2006/10

(57) ABSTRACT

A method of producing crystalline graphite, the method comprising: (a) providing a graphene/biomass mixture comprising multiple biomass particles (chips, granules, flakes, pellets, etc.) and a first amount of multiple sheets of a first graphene material, wherein the first graphene-to-biomass weight ratio is from 0 to 1.0; (b) heat-treating the mixture at a first temperature (150° C. to 1,500° C.) for a first period of time to carbonize the mixture into a graphene/carbon mixture; (c) optionally adding a second amount of multiple sheets of a second graphene material into the graphene/carbon mixture, wherein the second graphene-to-biomass weight ratio, based on the original non-carbonized biomass weight, is from 0 to 1.0 and the total graphene-to-biomass weight ratio is no less than 0.001; and (d) heat-treating the graphene/carbon mixture at a second temperature for a second period of time to produce a crystalline graphite, wherein the second temperature is selected from 900° C. to 3,500° C.

### FIELD

The present disclosure relates to the art of graphite materials and, in particular, to a method of producing a graphite material from a biomass or biochar feedstock.

### BACKGROUND

Carbon is known to have five unique crystalline structures, including diamond, fullerene (0-D nano graphitic material), carbon nano-tube or carbon nano-fiber (1-D nano graphitic material), graphene (2-D nano graphitic material), and graphite (3-D graphitic material). The carbon nano-tube (CNT) refers to a tubular structure grown with a single wall or multi-wall. Carbon nano-tubes (CNTs) and carbon nano-fibers (CNFs) have a diameter on the order of a few nanometers to a few hundred nanometers. Their longitudinal, hollow structures impart unique mechanical, electrical and chemical properties to the material. The CNT or CNF is a one-dimensional nano carbon or 1-D nano graphite material.

Bulk natural graphite powder is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). Although all the graphene planes in one grain are parallel to one another, typically the graphene planes in one grain and the graphene planes in an adjacent grain are different in orientation.

A new class of nano carbon material is graphene, a 2-D material having a hexagonal arrangement of carbon atoms. These honeycomb-like carbon atoms can form a free-standing sheet that is one-atom thick, which is now commonly referred to as a single-layer graphene sheet. Several layers of graphene planes can be bonded together to form a multi-layer graphene sheet or platelets, which contain less than 300 graphene planes or layers (or thinner than 100 nm), preferably less than 20 layers, and further preferably less than 10 layers (few-layer graphene). In both single-layer graphene and multi-layer graphene sheets, the graphene planes or edges can contain some non-carbon elements, such as hydrogen, oxygen, nitrogen, and fluorine, to name just a few. All these single-layer or multi-layer graphene sheets (0.34 nm to 100 nm thick) are herein collectively referred to as nano graphene platelets (NGPs). These include pristine graphene, graphene oxide, reduced graphene oxide, graphene fluoride, nitrogenated graphene, hydrogenated graphene, boron-doped graphene, etc. Graphene sheets can be obtained by exfoliating graphite materials using known processes.

Graphite is generally classified into natural graphite or artificial graphite (also commonly referred to as synthetic graphite). Mining of natural graphite is generally considered as a highly polluting process due to the extensive use of undesirable chemicals. Particles of synthetic or artificial graphite, hard carbons, and soft carbons may be prepared by graphitization of coke, or carbonization and graphitization of an organic synthetic polymeric material, petroleum pitch, coal tar pitch, and the like. However, production of synthetic graphite from the use of large quantities of petroleum or coal feedstock is not generally viewed as environmentally benign. Thus, it is highly desirable to develop eco-friendly, inexpensive carbon or graphite materials with scalable synthesis/fabrication processes from sustainable sources.

Thus, it is an object of the present disclosure to provide a method of cost-effectively producing graphite from a biomass or biochar feedstock. The resultant graphite can then be converted into graphene sheets. It is another object of the present disclosure to provide a method of cost-effectively producing graphite from mixtures of multiple biomass species without having to treat them separately.

### SUMMARY

The present disclosure provides a strikingly simple, fast, scalable, environmentally benign, and cost-effective process or method that meets the afore-mentioned needs. This method is capable of producing a graphite material (in a bulk or powder form) from a biomass or biochar feedstock.

In certain embodiments, the disclosure provides a method of producing crystalline graphite, the method comprising:
a) providing a graphene/biomass mixture of multiple biomass particles (chips, granules, pellets, flakes, etc.), preferably having a biomass particle size from 100 nm to 10 cm, and a first amount of multiple sheets of a first graphene material, wherein the first graphene-to-biomass weight ratio is from 0 to 1.0 (preferably from 0.001 to 0.5, more preferably from 0.005 to 0.3, and most preferably from 0.01 to 0.15);
b) heat-treating said graphene/biomass mixture at a first temperature selected from 250° C. to 1,500° C. for a first period of time to carbonize the graphene/biomass mixture into a graphene/carbon mixture;
c) optionally adding a second amount of multiple sheets of a second graphene material into the graphene/carbon mixture, wherein the second graphene-to-biomass weight ratio, based on the original non-carbonized biomass weight, is from 0 to 1.0 (preferably from 0.001 to 0.5, more preferably from 0.005 to 0.3, and most preferably from 0.01 to 0.15) and the total graphene-to-biomass weight ratio is no less than 0.001 (preferably from 0.01 to 0.5 and more preferably from 0.02 to 0.2), where the total graphene weight=first graphene weight+second graphene weight, and wherein the first graphene or the second graphene is selected from pristine graphene, having a carbon content greater than 99%, graphene oxide, reduced graphene oxide, halogenated graphene (graphene bromide, graphene fluoride, graphene chloride, graphene iodized, or a combination thereof), nitrogenated graphene, hydrogenated graphene, doped graphene, chemically functionalized graphene, or a combination thereof (graphene sheets are present during the first heat treatment, the second heat treatment, or both); and
d) heat-treating the graphene/carbon mixture, after step (b) or step (c), at a second temperature, higher than the first temperature, for a second period of time to produce a crystalline graphite, wherein the second temperature is selected from 900° C. to 3,500° C.

The biomass feedstock may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The biomass feedstock can be a mixture of different types of bio-species.

The biomass can contain lignocellulosic and/or non-lignocellulosic biomass. The lignocellulosic biomass is the most abundant non-edible type of biomass from forestry and agricultural wastes, and consists of mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, etc.

The nonlignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

In certain preferred embodiments, the doped graphene comprises graphene sheets doped or coated with element B, P, Ti, V, Cr, Mn, Fe, Co, Ni, Cu, Zn, Zr, Nb, Mo, Ru, Pd, Ag, Cd, Pt, Au, or a combination thereof. Any one or more than one type of these carbon yield-promoting and graphitization-facilitating elements may be coated on surfaces of biomass particles (during the first heat treating step).

In some embodiments, the graphene/biomass mixture in step (a) or the graphene/carbon mixture in step (c) further comprises a catalyst that comprises a transition metal selected from Ti, V, Cr, Mn, Fe, Co, Ni, Cu, Zn, Zr, Nb, Mo, Ru, Pd, Ag, Cd, Pt, Au, a combination thereof, or wherein the catalyst contains a chemical species selected from PdCl₂, FeCl₃, FeBr₃, FeF₃, NiBr₂, NiI₂, Cs₂CO₃, CsF, CsCl, CsBr, CH₂CL₂, or a combination thereof. The catalyst may be coated on surfaces of biomass particles, surfaces of graphene sheets, or simply mixed with biomass particles or graphene sheets.

In some embodiments, surface of the biomass particles and/or the surfaces of graphene sheets are coated with a polynuclear hydrocarbon material. Polynuclear hydrocarbons (also referred to as polycyclic aromatic hydrocarbons, PAHs, polyaromatic hydrocarbons, or polynuclear aromatic hydrocarbons) are hydrocarbons (organic compounds containing mostly carbon and hydrogen) that are essentially composed of multiple aromatic rings fused together (fused organic rings in which the electrons are delocalized). Preferably, the polynuclear hydrocarbon material is selected from the group consisting of and non-halogenated versions of naphthalene, anthracene, phenanthrene, tetracene, chrysene, triphenylene, pyrene, pentacene, benzo-pyrene, corannulene, benzo-perylene, coronene, ovalene, benzo-fluorene, petroleum pitch, coal tar pitch, halogenated versions thereof, chemical derivatives thereof, and combinations thereof

The chemically functionalized graphene may comprise a functional group selected from-OH, —COOH, —NH₂, —C═O, or a combination thereof.

The first temperature is preferably selected from 350° C. to 1,200° C. and/or the second temperature is preferably selected from 1,500° C. to 3,000° C.

The crystalline graphite produced by using this method typically contains graphite crystals having a length or width from 10 nm to 10 μm or an inter-graphene spacing from 0.335 nm to 0.38 nm. The graphite typically exhibits a degree of graphitization no less than 80%.

In some embodiments, the step of heating at the first temperature and the step of heating at the second temperature are conducted in different heating zones or different heating chambers; but they can be done at the same heating zone or in the same chamber. Steps (b), (c) and (d) may be conducted in a continuous manner.

In some embodiments, the second heat treatment temperature contains a temperature in the range of 1,500° C.-3,000° C. and the crystalline graphite has an inter-planar spacing from 0.336 nm to 0.36 nm, and a physical density no less than 1.6 g/cm³.

As compared to conventional processes, the presently disclosed method desirably involves significantly shorter preparation and heat treatment times and lower amounts of energy consumed, yet resulting in graphite materials that are of comparable or even higher degree of graphitization and, hence, higher thermal conductivity and/or higher electrical conductivity.

The presently disclosed method may further comprise a procedure to exfoliate or separate constituent graphene planes of the crystalline graphite into multiple graphene sheets. This can be conducted by using the well-known chemical oxidation, supercritical fluid exfoliation, liquid phase exfoliation, electrochemical exfoliation, mechanical shearing methods, etc.

### BRIEF DESCRIPTION OF THE DRAWINGS

FIG. 1 A flow chart showing the production of graphite from pieces (particles) of one or more than one type of biomass.

FIG. 2(A) An X-ray diffraction (XRD) curve of a graphitic material used to illustrate the procedure for calculating the degree of graphitization;

FIG. 2(B) Raman spectroscopy of a graphitic material used to illustrate the procedure for calculating the degree of graphitization.

### DETAILED DESCRIPTION

In certain embodiments, the disclosure provides a method of producing crystalline graphite from a feedstock of biomass particles (chips, granules, pellets, etc.). These biomass particles can comprise a single type of biomass or a mixture of a plurality of types of biomass. The feedstocks are then subjected to a carbonization procedure (e.g., at a temperature from 250° C. to 1,500° C.) and then a graphitization procedure (from 900° C. to 3,500° C.). However, one of the following conditions should be met: (i) the starting feedstock materials for the disclosed process preferably contains some discrete sheets of a graphene material prior to the carbonization procedure; (ii) adding some graphene sheets after the biomass feedstock is carbonized to become a carbonaceous material and prior to the subsequent graphitization procedure; and (iii) an amount of graphene sheets is added to the biomass feedstock before the carbonization procedure and, after the carbonization procedure, an additional amount of graphene sheets is added to the resultant graphene/carbon mixture prior to the graphitization procedure. The total weight of the graphene sheets added before and after carbonization should have a total graphene weight-to-biomass weight ratio no less than 0.0001, preferably no less than 0.001, and most preferably no less than 0.01. We have surprisingly observed that graphene sheets can improve the carbon yield of the carbonization procedure and increase the degree of graphitization of the resultant graphite, substantially crystalline graphite. It appears that graphene sheets can help attract and keep the carbon atoms, reducing the volatilization and escaping of carbon-containing species when biomass is being carbonized. The graphene sheets appear to also serve as seeds for promoting growth of graphite crystals.

In some embodiments, the disclosed method comprises: A) providing a graphene/biomass mixture of multiple biomass particles, having a biomass particle size from 10 nm to 10 cm, and a first amount of multiple sheets of a first graphene material, wherein the first graphene-to-biomass weight ratio is from 0 to 1.0 (preferably from 0.001 to 0.5, more preferably from 0.005 to 0.3, and most preferably from 0.01 to 0.15); B) heat-treating the graphene/biomass mixture at a first temperature selected from 250° C. to 1,500° C. for a first period of time to carbonize the graphene/biomass mixture into a graphene/carbon mixture; C) optionally adding a second amount of multiple sheets of a second graphene material into the graphene/carbon mixture, wherein the second graphene-to-biomass weight ratio, based on the original non-carbonized biomass weight, is from 0 to 1.0 (preferably from 0.001 to 0.5, more preferably from 0.005 to 0.3, and most preferably from 0.01 to 0.15) and the total graphene-to-biomass weight ratio is no less than 0.001 (preferably from 0.01 to 0.5 and more preferably from 0.02 to 0.2), where the total graphene weight=first graphene weight+second graphene weight, and wherein the first graphene or the second graphene is selected from pristine graphene, having a carbon content greater than 99%, graphene oxide, reduced graphene oxide, halogenated graphene (graphene bromide, graphene fluoride, graphene chloride, graphene iodized, or a combination thereof), nitrogenated graphene, hydrogenated graphene, doped graphene, chemically functionalized graphene, or a combination thereof; and D) heat-treating said graphene/carbon mixture, after step (B) or step (C), at a second temperature, higher than the first temperature, for a second period of time to produce a crystalline graphite, wherein the second temperature is selected from 900° C. to 3,500° C.

The first temperature is preferably selected from 350° C. to 1,200° C. and/or the second temperature is selected from 1,500° C. to 3,000° C. The carbonization and graphitization is preferably conducted in a non-oxidizing environment, preferably in vacuum or in a protective atmosphere (e.g., an inert gas and/or N₂ gas). In some embodiments, step (B) of carbonization is conducted under a pressure of 20 Psi to 1200 Psi (1 Psi=6.89 kPa).

The biomass feedstock may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The lignocellulosic biomass is the most abundant non-edible type of biomass from forestry and agricultural wastes, and consists of mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, etc. The non-lignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

As non-limiting examples, some of the biomass species that can be processed using the presently disclosed method are rice husk, recycled paper cup, hemp, shrimp or other types of soft shells, willow catkins, corn stalk, corn powder, corn cob, coconut shell, wheat straw, spruce bark, camphor leaves, banana peel, Copinus comatus, nori, honey suckles, waste peanut shell, eggplant, wood chips, seaweed, soya bean, glucose, etc. This list is meant to illustrate the fact that a wide variety of sustainable products can be used and processed into graphene sheets. One can even convert agricultural and wood waste into highly valuable products.

In certain preferred embodiments, the doped graphene comprises graphene sheets internally doped or surface-coated with element B, P, Ti, V, Cr, Mn, Fe, Co, Ni, Cu, Zn, Zr, Nb, Mo, Ru, Pd, Ag, Cd, Pt, Au, or a combination thereof. The graphene sheets having an exceptionally high specific surface area are capable of more uniformly dispersing these elements and allowing more of the atoms to be in contact with the constituent biomass, carbonaceous material, and/or growing graphite crystals.

In some embodiments, the graphene/biomass mixture in step (A) or the graphene/carbon mixture in step (C) further comprises a catalyst that comprises B, P, a transition metal selected from Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂, FeCl₃, FeBr₃, FeF₃, NiBr₂, NiI₂, Cs₂CO₃, CsF, CsCl, CsBr, CH₂CL₂, or a combination thereof.

The chemically functionalized graphene may comprise a functional group selected from-OH, —COOH, —NH₂, —C═O, or a combination thereof.

The first temperature is preferably selected from 350° C. to 1,200° C. (preferably 500° C. to 1,000° C.) and/or the second temperature is selected from 1,500° C. to 3,000° C. (preferably 2,000° C. to 2,800° C.). With help from graphene sheets, graphitization can proceed well at a temperature significantly lower than 2,500° C., or even lower than 2,300° C., in contrast to the typical graphitization temperature range of 2,800-3,200° C.

In certain desired embodiments, the biomass particles comprise a biomass waste. The biomass may comprise multiple types of biomass species that are mixed together.

The crystalline graphite produced by using this method typically contains graphite crystals having a length or width from 10 nm to 10 μm or an inter-graphene spacing from 0.335 nm to 0.38 nm. The graphite typically exhibits a degree of graphitization no less than 80%.

A graphene sheet or nano graphene platelet (NGP) is essentially composed of a graphene plane (hexagonal lattice of carbon atoms) or multiple graphene planes stacked and bonded together (typically up to 10 graphene planes per multi-layer platelet). Each graphene plane, also referred to as a graphene sheet, comprises a two-dimensional hexagonal structure of carbon atoms. Each platelet has a length and a width parallel to the graphene plane and a thickness orthogonal to the graphene plane. By definition, the thickness of an NGP can be 100 nanometers (nm) or smaller (preferably containing no greater than 10 hexagonal planes), with a single-sheet NGP, also referred to as single-layer graphene, being as thin as 0.34 nm.

The methods of producing pristine graphene, graphene oxide (GO), reduced graphene oxide (RGO), halogenated graphene (graphene bromide, graphene fluoride, graphene chloride, graphene iodized, or a combination thereof), nitrogenated graphene, hydrogenated graphene, doped graphene, and chemically functionalized graphene are well known in the art. However, it has not been known in the art that various different graphene sheets are capable of improving the chemical conversion of biomass into graphite in terms of increasing the carbon yield during carbonization of biomass and the degree of graphitization of the resultant graphite materials.

Also previously unknown is the notion that mixtures of various different types of biomass species can be well converted into biomass with the presently disclosed method of adding graphene sheets.

Degree of graphitization (G) may be measured using X-ray diffraction (XRD) or Raman spectroscopy method. A material with high degree of graphitization will have a structure with well-ordered graphite like form with sp2 hybridized carbon atoms assembled in a planar hexagonal lattice. Therefore, such material will exhibit good mechanical properties with high electrical and thermal conductivity.

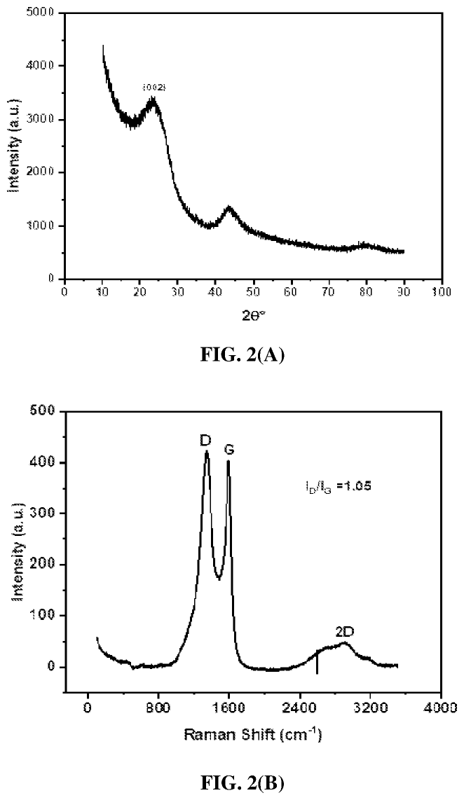

The XRD data (e.g., as illustrated in FIG. 2(A)) can be used to calculate the degree of graphitization (G) from the interplanar spacing (d) using the below equation:

$$G = \frac{{d}_{002} - {d}_{002 sample}}{{d}_{002} - {d}_{graphite}}$$

Where d₀₀₂ can be estimated from Bragg equation:

$${d}_{002} = \frac{λ}{2 sin {θ}_{002}}$$

d₀₀₂ is the interplanar spacing of the (002) XRD peak in graphite 0.3440, d (sample) is the interplanar spacing of the (002) XRD peak of the sample, and d (graphite) is the interplanar spacing of the (002) XRD peak of the highly ordered graphite. The value of d (graphite) is known and can be used as a reference for determining the degree of graphitization of other carbon materials. For highly ordered graphite, d (002) is around 0.3354 nm. Thus, we have

$$G = \frac{0.3440 - {d}_{002 sample}}{0.3440 - 0.3354} ,$$

which is commonly referred to as the Mering's Eq,

Raman spectroscopy can also be used to study the degree of graphitization of carbon materials as it provides useful information on the structural and electronic properties of the carbon material. Carbon material with high degree of graphitization has a structure with well-ordered graphite like form with sp2 hybridized carbon atoms assembled in a planar hexagonal lattice. As a result, sharp and high intensity Raman signals corresponding to the characteristic G and 2D bands of graphitic carbon can be observed along with a weak Raman signal corresponding to the characteristic D (illustrated in FIG. 2(B)). The intensity of D/G ratio provides information about the degree of graphitization. While the lower value of the ID/IG suggests a high degree of graphitization, the high value ID/IG ratio indicates a more disordered or amorphous structure.

Graphene sheets may be internally doped or surface-coated with element B, P, Ti, V, Cr, Mn, Fe, Co, Ni, Cu, Zn, Zr, Nb, Mo, Ru, Pd, Ag, Cd, Pt, Au, or a combination thereof. Internal doping may be accomplished by ion implementation (e.g., B ion implementation). Surface coating of the aforementioned elements may be conducted by using physical vapor deposition, chemical vapor deposition, sputtering, solution deposition, etc. The graphene sheets having an exceptionally high specific surface area are capable of more uniformly dispersing these elements and allowing more of the atoms to be in contact with the constituent biomass, carbonaceous material, and/or growing graphite crystals.

The graphene/biomass mixture in step (A) or the graphene/carbon mixture in step (C) may further comprise a catalyst that comprises a transition metal selected from Ti, V, Cr, Mn, Fe, Co, Ni, Cu, Zn, Zr, Nb, Mo, Ru, Pd. Ag. Cd. Pt, Au, a combination thereof, or wherein the catalyst contains a chemical species selected from PdCl₂, FeCl₃, FeBr₃, FeF₃, NiBr₂, NiI₂, Cs₂CO₃, CsF, CsCl, CsBr, CH₂CL₂, or a combination thereof. These chemical species may be sprayed over or coated on the surfaces of the biomass particles and/or the surfaces of graphene sheets.

In some embodiments of the present disclosure, the surfaces of the biomass particles and/or the surfaces of graphene sheets may be coated with a polynuclear hydrocarbon material. Alternatively, a polynuclear hydrocarbon material may be introduced as a vapor into the heat treatment chamber of graphite production. We have surprisingly observed that such a polynuclear hydrocarbon material behaves like a catalyst or a graphitization promoter. Polynuclear hydrocarbons (also referred to as polycyclic aromatic hydrocarbons, PAHs, polyaromatic hydrocarbons, or polynuclear aromatic hydrocarbons) are hydrocarbons (organic compounds containing mostly carbon and hydrogen) that are essentially composed of multiple aromatic rings fused together (fused organic rings in which the electrons are delocalized).

Prior to the first heat treatment, the starting PAHs contain mostly or substantially all fused rings (e.g., chlorinated anthracene). Although not preferred, the starting aromatic materials in the instant process may be selected from those containing isolated benzene rings that are connected by a linear chain or bond (e.g., 2′-chloro-1,1′:4′,1″-terphenyl). Herein, PAHs include those having further branching substituents on these ring structures. The simplest of such chemicals are naphthalene, having two aromatic rings, and the three-ring compounds anthracene and phenanthrene. Briefly, examples of PAHs are halogenated and non-halogenated versions of naphthalene, anthracene, phenanthrene, tetracene, chrysene, triphenylene, pyrene, pentacene, benzo-pyrene, corannulene, benzo-perylene, coronene, ovalene, and benzo-fluorene. PAHs of interest here typically have from 2 to 20 aromatic rings (approximately 10 to 60 carbon atoms) fused together, more typically from 2 to 10 rings (approximately 10 to 32 carbon atoms). However, they can have a larger number of fused rings or fused polycyclic aromatics.

Petroleum- or coal-derived pitch is a mixture of larger polynuclear hydrocarbons with an average molecular weight of approximately 200 amu (approximately 180-200 carbon atoms or 60-66 rings). Each pitch product is a mixture of many different types and sizes of polynuclear hydrocarbons. There are also a variety of impurities (1-10% by weight) in such pitch materials. In contrast, those PAHs mentioned above are substantially impurity-free.

It appears that graphene sheets can help attract and retain the carbon atoms, preventing or reducing the carbon-containing species from escaping when biomass is being carbonized. The graphene sheets appear to also serve as seeds, providing active sites for attachment of carbon atoms thereto to form fused rings (hexagonal carbon or benzene ring type structure) and growing these rings. Possibly for these reasons, the carbon yield during the carbonization of biomas is found to be significantly increased with the presence of graphene sheets. At a higher treatment temperature (graphitization temperature), graphene sheets appear to be capable of promoting growth of graphite crystals. The presence of PAH molecules presumably provides readily formed rings to be merged with growing honeycomb-like (hexagonal) planes.

During carbonization of biomass particles (preferably from 300° C. to 1,500° C.), polymer chains are broken into pieces, forming smaller molecules. Concurrently, the molecules undergo dehydrogenation reactions that entail removal of non-carbon atoms, such as O, Cl, Br, H and N, and lateral merging of fused aromatic rings, if present, to form longer and wider aromatic molecules (polyaromatic molecules) or more aromatic rings fused together in the length and width directions, much like growing polymer chains. Such a structure of fused aromatic rings can grow to contain up to 300 carbon atoms or approximately 100 rings fused together. Such a structure is an incipient graphene sheet. The graphene sheets and/or polycyclic aromatic hydrocarbon (PAH) molecules added into the mixture seem to play a positive role of promoting these reactions.

As the heat treatment temperature is increased (e.g., higher than 600° C., up to 1,500° C.). these incipient graphene sheets continue to grow in lateral dimensions (length and width) which can reach several micrometers (0.5-100 μm and more typically 1-10 μm) and the resulting graphene sheets can each contain many hundreds or thousands of fused rings. These dimensions and number of fused rings can be determined by using transmission electron microscopy (TEM) and atomic force microscopy (AFM).

As the polyaromatic molecules grow at a high heat treatment temperature, the cohesive energy between polyaromatic molecules can eventually exceed the translational energy of individual polyaromatic molecules, resulting in the homogeneous nucleation of a new phase, called the mesophase. The polyaromatic molecules that constitute the mesophase are discotic, with one axis much smaller than the other two axes. These planar molecules can arrange themselves with the planes parallel to each other, forming nematic liquid crystals. Since these liquid crystals are substantially in a dried solid state, continued heat treatments enable these liquid crystals to grow in dimensions to eventually become graphene domains or graphite single crystals.

The graphene sheets and PAHs may be preferably attached with some desired functional groups that facilitate or promote edge-to-edge chemical merging or linking between neighboring aromatic molecules during heat-treating. For instance, functional group such as —OH, —COOH, —NH₂, and —C═O attached at the edges of aromatic molecules can promote merging between molecules.

In certain embodiments, the functional group may be selected from SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly (alkylether), R″ is fluoroalkyl, fluoroaryl, fluorocycloalkyl, fluoroaralkyl or cycloaryl, X is halide, and Z is carboxylate or trifluoroacetate.

Other useful chemical functional groups or reactive molecules may be selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), hexamethylenetetramine, polyethylene polyamine, polyamine epoxy adduct, phenolic hardener, non-brominated curing agent, non-amine curatives, and combinations thereof. These functional groups are multi-functional, with the capability of reacting with at least two chemical species from at least two ends. Most importantly, they are capable of bonding to the edge or surface of aromatic molecules using one of their ends and, during subsequent heat treatments, are able to react with proper functional groups from adjacent aromatic molecules.

The functional group may be selected from OY, NHY, O═C—OY, P═C—NR′Y, O═C—SY, O═C—Y, —CR′1-OY, N′Y or C′Y, and Y is an appropriate functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′2, R′SH, R′CHO, R′CN, R′X, R′N′(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

A properly programmed heat treatment procedure for heat treating the biomass/graphene mixtures can involve at least two heat treatment temperatures (first temperature for a period of time and then raised to a second temperature and maintained at this second temperature for another period of time), or any other combination of at least two heat treatment temperatures (HTT) that involve a first temperature and a second HTT, higher than the first.

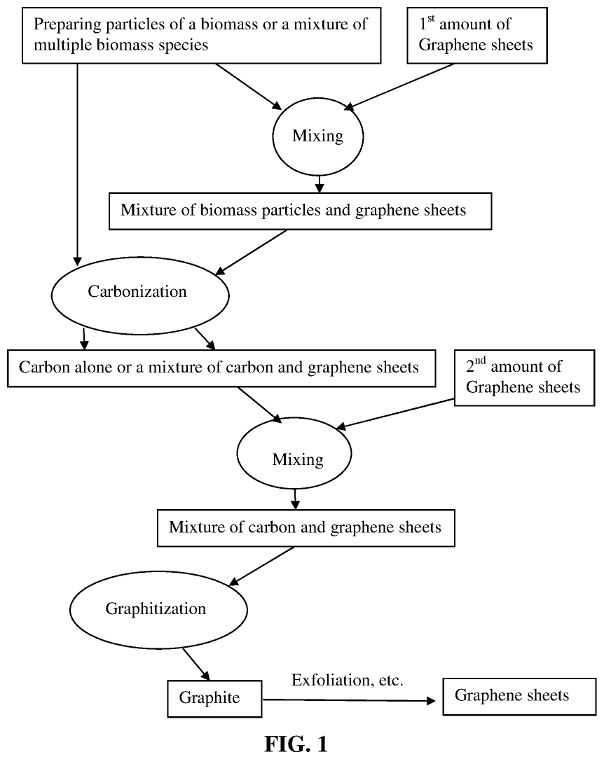

As shown in the bottom portion of FIG. 1, the presently disclosed method may further comprise a procedure to exfoliate or separate constituent graphene planes of the crystalline graphite into multiple graphene sheets. This can be conducted by using the well-known chemical oxidation, supercritical fluid exfoliation, liquid phase exfoliation, electrochemical exfoliation, mechanical shearing methods, etc.

The following examples serve to provide the best modes of practice for the presently disclosed method and should not be construed as limiting the scope of the process:

### Example 1: Preparation of Discrete GO Sheets and GO-Assisted Carbonization and/or Graphitization of Non-Lignocellulosic Biomass (e.g., Fruit)

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was exfoliated in an oven pre-set at 1,050° C. for 2 minutes to obtain graphene oxide (GO) sheets.

Powder of graphitic materials was produced from heat treated fruit-based non-lignocellulosic biomass with the assistance of B-coated GO sheets. In one example (Sample 1-D), surfaces of GO sheets were bonded with amorphous boron (B) particles. This was accomplished by dispersing Go sheets and B particles in an adhesive solution, followed by drying the slurry in a vacuum oven over night. The biomass particles and GO sheets (with or without B), plus fine Zn particles (only in Sample 1-E), were mixed and subjected to carbonization and graphitization treatments. In a comparative sample, no GO sheets were implemented.

The fruits of glossy privet were washed and dried at 80° C. for 6 h. Then, the B-coated GO sheets and the fruits (22.328 g) were put into an autoclave (0.5 L) containing deionized water (200 mL), where the GO-to-fruit mass ratios were 1/100 and 1/10 in two separate samples. The autoclave was subjected to a hydrothermal reaction at 195° C. for 24 h. A dark-brown biochar solid was obtained by filtrating, washing with deionized water until reaching a neutral state, followed by drying at 70° C. for 3 h.

In one sample, biochar with mixed with approximately 1% by weight of B-coated GO sheets. In a typical procedure, the mixture was placed in a tube furnace and heated to 900° C. at a ramping rate of 5° C./min and held for 1 h. To create an inert atmosphere, N₂ gas was flowed through the furnace throughout the heat treatment. The mixtures were graphitized in a box-type furnace equipped with graphite heating elements. Graphitization was conducted at 2,300° C. or 2400° C. (Sample 1-E) for 1 h under the protection of a flowing helium gas. The carbon yield was obtained by measuring and calculating the amount of carbon powder (minus GO amount) divided by the original biomass particle weight. The degree of graphitization was calculated by using the Merling's equation based on X-ray diffraction data. Testing data are summarized in Table 1 below.

TABLE 1
Testing data (Tca = carbonization temperature; Tgr = graphitization temperature)

| | | | Graphene | | | | |
|---|---|---|---|---|---|---|---|
| Sample | % | Type of | doping or | | Tca (° C.); | Carbon | Degree of |
| ID | GO | biomass | coating | Catalyst | Tgr (° C.) | yield | graphitization |
| 1-A | 0 | glossy privet | none | none | Tca = 900 | 21.6% | Not graphitizable |
| 1-B | 0.01% | glossy privet | none | none | Tca = 900 | 25.4% | 60.7% |
| | | | | | Tgr = 2,300 | | |
| 1-C | 1% | glossy privet | none | none | Tca = 900 | 30.2% | 73.6% |
| | | | | | Tgr = 2,300 | | |
| 1-D | 1% | glossy privet | B coating | none | Tca = 900 | 32.5% | 78.7% |
| | | | | | Tgr = 2,300 | | |
| 1-E | 2.5% | glossy privet | none | Zn | Tca = 900 | 34.4% | 81.2% |
| | | (65%) | | | Tgr = 2,400 | | |

These data have clearly demonstrated that adding some graphene sheets in pieces of biomass can significantly increase the carbon yield and the degree of graphitization when heat-treating the mixture. The post-consumer biomass can be up-cycled to some useful products, such as graphite.

### Example 2: Preparation of Graphene Sheets from Meso-Carbon Micro-Beads (MCMBs) and Graphene-Assisted Production of Graphite from Non-Lignocellulosic Biomass (e.g., Chitosan)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours. The slurry was then dried and strayed using a spray dryer to obtain slightly reduced GO sheets (RGO).

Chitosan is an abundant type of biomass (e.g., from shrimp shell). Chitosan may be converted into graphite with or without using a catalyst. In the present study, a two-step procedure was conducted, which included using FeCl₃ as a catalyst in a chitosan/FeCl₃ mixture and heat-treating the mixture. The residual Fe could be removed and recovered by acid washing. In a typical process, chitosan and FeCl₃ were mixed in de-ionized (DI) water and dried at 80° C. to obtain a brown chitosan/FeCl₃ mixture. Then, the mixture was heated in a sealed furnace under Ar atmosphere at 400° C. for 2 hours to generate a powder mixture. After this first heat treatment procedure, the mixture was immersed in 1 M HCl for 1 hour to remove the Fe. The sample was dried overnight in a vacuum oven at 60° C. to form solid powder of a biochar.

These RGO sheets were then mixed with the biochar powder. The sample preparation procedures and heat treatment conditions are similar to those of Example 1, but Tca and Tgr are different. The data summarized in Table 2 below again clearly demonstrate that adding some graphene sheets in pieces of biomass can significantly increase the carbon yield and the degree of graphitization.

TABLE 2
Testing data (Tca = carbonization temperature; Tgr = graphitization temperature)

| | | | Graphene | | | | |
|---|---|---|---|---|---|---|---|
| Sample | % | Type of | doping or | | Tca (° C.); | Carbon | Degree of |
| ID | RGO | biomass | coating | Catalyst | Tgr (° C.) | yield | graphitization |
| 2-A | 0 | Chitosan | none | none | Tca = 800 | 23% | 56.4% |
| | | | | | Tgr = 2,500 | | |
| 2-B | 1% | Chitosan | none | 2% pitch | Tca = 800 | 33.2% | 76% |
| | | | | | Tgr = 2,500 | | |
| 2-C | 5% | Chitosan | Cu coating | none | Tca = 800 | 40.4% | 82.8% |
| | | | | | Tgr = 2,500 | | |

### Example 3: Preparation of Graphite from Lignocellulosic Biomass (e.g., Kraft Lignin) with Pristine Graphene Sheets

Pristine graphene sheets were produced by using the direct ultrasonication or liquid-phase production process. In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

The Kraft lignin with iron ions was prepared by the co-precipitation method. In a representative procedure, thirty (30) grams of Kraft lignin was first added to 30 mL tetrahydrofuran in a glass beaker and stirred for 2 h. Separately, 25 grams of iron (III) nitrate was added to 20 mL DI water in a smaller glass beaker and the mixture was stirred until dissolved completely. Subsequently, the iron nitrate solution was added drop-wise to the Kraft lignin solution and stirred for 2 h. The mixture was sealed in an autoclave and heated at 180° C. for 4 hours. The resulting partially reacted mixture was transferred to an oven where it was dried at 80° C. for 24 h. These particles, along with 1.5-2.0% by weight of pristine graphene, were packed in the middle of a 1-inch OD, stainless steel tubular reactor. The reactor was heated at a rate of 10° C./min to 1,500° C. and maintained at 1,500° C. for 1 h. Then, the furnace was cooled down at a rate of 10° C./min to room temperature. Another batch of sample was prepared in a similar manner, but the temperature was raised to 2,400° C. and maintained at this temperature for 2 hours.

The data summarized in Table 3 below further demonstrate that adding some graphene sheets in pieces of biomass can significantly increase the carbon yield and the degree of graphitization of the heat treatment products.

TABLE 3
Testing data (Tca = carbonization temperature; Tgr = graphitization temperature)

| | | | Graphene | | | | |
|---|---|---|---|---|---|---|---|
| Sample | % | Type of | doping or | | Tca (° C.); | Carbon | Degree of |
| ID | graphene | biomass | coating | Catalyst | Tgr (° C.) | yield | graphitization |
| 3-A | 0 | Kraft lignin | none | none | Tca = 180 | <10% | Non- |
| | | | | | Tgr = 2,400 | | graphitizable |
| 3-B | 2% | Kraft lignin | none | Fe | Tca = 180 | 33% | 84% |
| | | | | | Tgr = 2,400 | | |
| 3-C | 1.5% | Kraft lignin | none | none | Tca = 180 | 36% | 83.5% |
| | | | | | Tgr = 2,400 | | |

### Example 4: Preparation Graphite from Lignocellulosic Biomass (e.g., Cellulose) and Graphene Fluoride (as an Example of Halogenated Graphite)

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). % Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

The precursor cellulose was prepared by mechanical milling. In a representative process, 50 g of bleached kraft pulp was loaded to a 500 ml PTFE pot containing zirconia balls of three size and numbers: 2 of 20 mm diameter, 100 of 10 mm diameter, and 300 of 6 mm diameter (631 g in total). Milling was conducted by a planetary ball mill at 300 rpm for 24 h. The obtained milled sample was mixed with graphene fluoride powder (20/1 ratio) and the mixture was calcined in a furnace at a temperature (700° C.) for 1 h with a heating rate of 10° C./min under a nitrogen atmosphere. The carbonized sample was further treated at a temperature of 2,300° C. The addition of 2% by weight of graphene fluoride was found to increase the degree of graphitization from 75% to 87%.

### Example 5: Nitrogenated Graphene-Assisted Preparation of Graphite from Mixed Lignocellulosic/Non-Lignocellulosic Biomass

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene: urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis.

Sugarcane bagasse pith was obtained by squeezing and extracting sugarcane juice from the sugarcane purchased from a supermarket. Then, the sugarcane bagasse pith (5 g) was suspended in 500 ml of distilled water containing 1 wt % glacial acetic acid dissolved therein. Chitosan (2.14 g) was then added into the acetic solution with continuous stirring until chitosan was completely dissolved. The resulting suspension was stirred for about 5 h at room temperature, and dried at 80° C. in an oven. The sugarcane bagasse pith/chitosan mixture was first heat-treated in an autoclave (180° C. at 2 atm pressure) for 1 hr. The resulting partially carbonized mass was mixed with 5% nitrogenated graphene sheets and the mixture was heated in a tube furnace for 1 h at 1,400° C. in Ar atmosphere with a ramp rate of 10° C./min. The sample was further treated at 2,500° C. for 2 hours to obtain a sample of biochar-derived graphite particles.

The addition of 5% by weight of nitrogenated graphene was found to increase the degree of graphitization from less than 76% to 88.6%. A sample of graphite was then exfoliated into graphene sheets using the liquid phase exfoliation method.

1. A method of producing crystalline graphite from a biomass feedstock, said method comprising:
A) providing a graphene/biomass mixture comprising multiple biomass particles, having a biomass particle size from 10 nm to 10 cm, and a first amount of multiple sheets of a first graphene material, wherein the first graphene-to-biomass weight ratio is from 0 to 1.0;
B) heat-treating said graphene/biomass mixture at a first temperature selected from 150° C. to 1,500° C. for a first period of time to carbonize the graphene/biomass mixture into a graphene/carbon mixture; and
C) heat-treating said graphene/carbon mixture, at a second temperature, higher than the first temperature, for a second period of time to produce a crystalline graphite, wherein the second temperature is selected from 900° C. to 3,500° C.

2. The method of claim 1, wherein the biomass feedstock comprises a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof.

3. The method of claim 2, wherein said lignocellulosic biomass is selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, or a combination thereof.

4. The method of claim 2, wherein said non-lignocellulosic biomass is selected from food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, or a combination thereof.

5. The method of claim 1, further including adding a second amount of multiple sheets of a second graphene material into the graphene/carbon mixture, wherein the second graphene-to-biomass weight ratio, based on the original non-carbonized biomass weight, is from 0 to 1.0 and the total graphene-to-biomass weight ratio is no less than 0.001, where the total graphene weight=first graphene weight+second graphene weight, and wherein the first graphene or the second graphene is selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof; and

6. The method of claim 5, wherein the doped graphene comprises graphene sheets doped or coated with element B, P, Ti, V, Cr, Mn, Fe, Co, Ni, Cu, Zn, Zr, Nb, Mo, Ru, Pd, Ag, Cd, Pt, Au, or a combination thereof.

7. The method of claim 5, wherein the graphene/biomass mixture in step (A) or the graphene/carbon mixture further comprises a catalyst that comprises a transition metal selected from Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂, FeCl₃, FeBr₃, FeF₃, NiBr₂, NiI₂, Cs₂CO₃, CsF, CsCl, CsBr, CH₂Cl₂, or a combination thereof.

8. The method of claim 5, wherein said biomass comprises an additive dispersed in said biomass during said first heat treating step or in said biochar during the second heat-treating step, wherein said additive is selected from a catalyst, a template, an activator or activation agent, a chemical functionalization agent, or a combination thereof.

9. The method of claim 8, wherein said activation agent is selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

10. The method of claim 1, wherein surface of the biomass particles and/or the surfaces of graphene sheets are coated with a polynuclear hydrocarbon material.

11. The method of claim 10, wherein the polynuclear hydrocarbon material is selected from the group consisting of and non-halogenated versions of naphthalene, anthracene, phenanthrene, tetracene, chrysene, triphenylene, pyrene, pentacene, benzo-pyrene, corannulene, benzo-perylene, coronene, ovalene, benzo-fluorene, petroleum pitch, coal tar pitch, halogenated versions thereof, chemical derivatives thereof, and combinations thereof.

12. The method of claim 1, wherein the first temperature is selected from 350° C. to 1,200° C. or the second temperature is selected from 1,500° C. to 3,000° C.

13. The method of claim 1, wherein the total graphene-to-biomass weight ratio is from 0.01 to 0.5.

14. The method of claim 1, wherein step (B) of carbonization is conducted under a pressure of 20 Psi to 1200 Psi.

15. The method of claim 1, wherein said crystalline graphite contains graphite crystals having a length or width from 10 nm to 10 μm or an inter-graphene spacing from 0.335 nm to 0.38 nm.

16. The method of claim 5, wherein said chemically functionalized graphene comprises a functional group selected from —OH, —COOH, —NH₂, —C—O, or a combination thereof.

17. The method of claim 1, wherein said heating at the first temperature and heating at the second temperature are conducted in different heating zones or different heating chambers.

18. The method of claim 5, wherein the steps are conducted in a continuous manner.

19. The method of claim 1, wherein said second heat treatment temperature contains a temperature in the range of 1,500° C.-3,000° C. and the crystalline graphite has an inter-planar spacing from 0.3354 nm to 0.36 nm, and a physical density no less than 1.6 g/cm³.

20. The method of claim 1, wherein the graphite exhibits a degree of graphitization no less than 80%.

21. The method of claim 1, wherein the method further comprises a procedure to exfoliate or separate constituent graphene planes of the crystalline graphite into multiple graphene sheets.

22. A method of producing crystalline graphite from a biomass feedstock, said method comprising:
A) providing a graphene/biomass mixture comprising multiple biomass particles, having a biomass particle size from 10 nm to 10 cm, and a first amount of multiple sheets of a first graphene material, wherein the first graphene-to-biomass weight ratio is from 0 to 1.0;
B) heat-treating said graphene/biomass mixture at a first temperature selected from 150° C. to 1,500° C. for a first period of time to carbonize the graphene/biomass mixture into a graphene/carbon mixture;
C) adding a second amount of multiple sheets of a second graphene material into the graphene/carbon mixture, wherein the second graphene-to-biomass weight ratio, based on the original non-carbonized biomass weight, is from 0 to 1.0 and the total graphene-to-biomass weight ratio is no less than 0.001, where the total graphene weight=first graphene weight+second graphene weight, and wherein the first graphene or the second graphene is selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof; and
D) heat-treating said graphene/carbon mixture, after step (B) or step (C), at a second temperature, higher than the first temperature, for a second period of time to produce a crystalline graphite, wherein the second temperature is selected from 900° C. to 3,500° C.
